(19) United States
(12) Patent Application Publication
(10) Pub. No.: US 2023/0361489 A1
(43) Pub. Date: Nov. 9, 2023

(54) ANTENNA DEVICE, RADAR MODULE, AND COMMUNICATION MODULE

(71) Applicant: Murata Manufacturing Co., Ltd., Kyoto (JP)

(72) Inventor: Hiroshi NISHIDA, Kyoto (JP)

(21) Appl. No.: 18/355,829

(22) Filed: Jul. 20, 2023

Related U.S. Application Data
(63) Continuation of application No. PCT/JP2021/038990, filed on Oct. 21, 2021.

(30) Foreign Application Priority Data
Jan. 25, 2021 (JP) 2021-009627

(51) Int. Cl. H01Q 1/22; H01Q 21/28

(52) U.S. Cl. CPC H01Q 21/28; H01Q 1/2283

(57) ABSTRACT

A radiating electrode is disposed with a space from a ground conductor plate included in a substrate, in a thickness direction of the substrate. A dielectric member is loaded on the radiating electrode. The dielectric member includes two dielectric block portions disposed with a distance in an excitation direction of the radiating electrode. The two dielectric block portions are disposed across a geometric center of the radiating electrode in plan view, and, in plan view, a portion of each of the two dielectric block portions overlaps a portion of the radiating electrode and a remaining portion of each of the two dielectric block portions is disposed outside the radiating electrode.

### CROSS REFERENCE TO RELATED APPLICATION

This is a continuation of International Application No. PCT/JP2021/038990 filed on Oct. 21, 2021 which claims priority from Japanese Patent Application No. 2021-009627 filed on Jan. 25, 2021. The contents of these applications are incorporated herein by reference in their entireties.

### BACKGROUND ART

### Technical Field

The present disclosure relates to an antenna device, a radar module, and a communication module.

Loading a dielectric block on a radiating electrode of a patch antenna enables aperture efficiency to be increased (see Patent Document 1 below, for example). In the patch antenna disclosed in the following Patent Document 1, a dielectric block is loaded for each radiating electrode such that the dielectric block completely covers the radiating electrode of the patch antenna.

Patent Document 1: Japanese Unexamined Patent Application Publication No. 1-243605

### BRIEF SUMMARY

There is a limit to an increase in antenna gain by loading a dielectric block on a radiating electrode of a patch antenna with a method in the past. In order to obtain a desired antenna gain, the number of radiating electrodes needs to be increased. When the number of radiating electrodes is increased, a length of a feed line to each of the radiating electrodes becomes longer, resulting in an increase in transmission line loss. Therefore, an effect of increasing the antenna gain, obtained by increasing the number of radiating electrodes, is diminished.

The present disclosure provides an antenna device capable of further increasing antenna gain as compared with a configuration in the past, by loading a member made of dielectric on a radiating electrode of a patch antenna. Another object of the present disclosure is to provide a radar module and a communication module in which the antenna device is equipped.

According to one aspect of the present disclosure, provided is an antenna device including
a substrate including a ground conductor plate,
a radiating electrode disposed on the substrate with a space from the ground conductor plate in a thickness direction of the substrate, and
a dielectric member loaded on the radiating electrode,
in which the dielectric member includes two dielectric block portions disposed with a distance in a first direction being an excitation direction of the radiating electrode, and
the two dielectric block portions are disposed across a geometric center of the radiating electrode in plan view, and, in plan view, a portion of each of the two dielectric block portions overlaps a portion of the radiating electrode and a remaining portion of each of the two dielectric block portions is disposed outside the radiating electrode.

According to another aspect of the present disclosure, provided is a radar module including
a substrate including a ground conductor plate,
a plurality of antenna elements for transmission provided on the substrate,
a plurality of antenna elements for reception configured to receive a radio wave radiated from the plurality of antenna elements for transmission and reflected by a target, and
a signal processing circuit configured to process a signal received by the plurality of antenna elements and to generate position information of the target,
in which each of the plurality of antenna elements includes
a plurality of radiating electrodes disposed on the substrate with a space from the ground conductor plate in a thickness direction of the substrate and
a plurality of dielectric members loaded on the respective plurality of radiating electrodes,
an excitation direction of the plurality of radiating electrodes is parallel to a first direction,
the plurality of antenna elements is aligned in a direction orthogonal to the first direction in plan view,
each of the plurality of dielectric members includes
two dielectric block portions disposed with a distance in the first direction, and
the two dielectric block portions are disposed, in plan view, across a geometric center of a radiating electrode on which the dielectric member is loaded, and, in plan view, a portion of each of the two dielectric block portions overlaps a portion of the radiating electrode on which the dielectric member is loaded and a remaining portion of each of the two dielectric block portions is disposed outside the radiating electrode.

According to yet another aspect of the present disclosure, provided is a communication module including
a substrate including a ground conductor plate,
a plurality of antenna elements provided on the substrate, and
a radio frequency integrated circuit element that supplies a radio frequency signal to the plurality of antenna elements and down-converts a radio frequency signal received by the plurality of antenna elements into an intermediate frequency signal or a baseband signal,
in which each of the plurality of antenna elements includes
a plurality of radiating electrodes disposed on the substrate with a space from the ground conductor plate in a thickness direction of the substrate, and
a plurality of dielectric members loaded on the respective plurality of radiating electrodes,
an excitation direction of the plurality of radiating electrodes is parallel to a first direction,
the plurality of antenna elements is aligned in a direction orthogonal to the first direction in plan view,
each of the plurality of dielectric members includes
two dielectric block portions disposed with a distance in the first direction, and
the two dielectric block portions are disposed, in plan view, across a geometric center of a radiating electrode on which the dielectric member is loaded, and, in plan view, a portion of each of the two dielectric block portions overlaps a portion of the radiating electrode on which the dielectric member is loaded and a remaining portion of each of the two dielectric block portions is disposed outside the radiating electrode.

Making two dielectric block portions be included in a dielectric member loaded on a radiating electrode makes it possible to increase antenna gain of an antenna device.

### BRIEF DESCRIPTION OF THE DRAWINGS

FIG. 1 is a perspective view of an antenna device according to a first embodiment.

FIG. 2A is a plan view of the antenna device according to the first embodiment, and FIG. 2B is a sectional view of the antenna device in FIG. 2A taken along a dashed-and-dotted line 2B-2B.

FIG. 3 is a perspective view of an antenna device according to a comparative example.

FIG. 4A and FIG. 4B are graphs illustrating directional characteristics in a yz plane and an xz plane, respectively.

FIG. 5A and FIG. 5B are graphs illustrating directional characteristics in the yz plane and the xz plane, respectively, obtained with a simulation model differentiating a distance between two dielectric block portions 40A.

FIG. 6 is a graph illustrating a relationship of a distance between two dielectric block portions and antenna gain in a front direction.

FIG. 7A is a perspective view of an antenna device according to a second embodiment, and FIG. 7B and FIG. 7C are each a perspective view of an antenna device according to a modification of the second embodiment.

FIG. 8A and FIG. 8B are a perspective view and a sectional view of an antenna device according to a third embodiment, respectively.

FIG. 9 is a perspective view of an antenna device according to a fourth embodiment.

FIG. 10 is a plan view of an antenna device according to a fifth embodiment.

FIG. 11A and FIG. 11B are a perspective view and a plan view of an antenna device according to a sixth embodiment, respectively.

FIG. 12A and FIG. 12B are a perspective view and a plan view of an antenna device according to a seventh embodiment, respectively.

FIG. 13 is a plan view of an antenna device equipped on a radar module according to an eighth embodiment.

FIG. 14 is a block diagram of the radar module according to the eighth embodiment.

FIG. 15 is a block diagram of a communication module according to a ninth embodiment.

### DETAILED DESCRIPTION

### First Embodiment

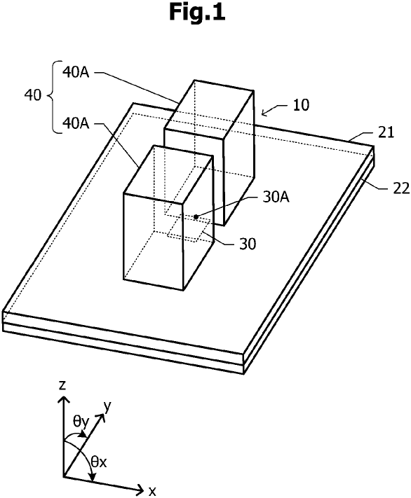

An antenna device according to a first embodiment will be described with reference to FIG. 1 to FIG. 6.

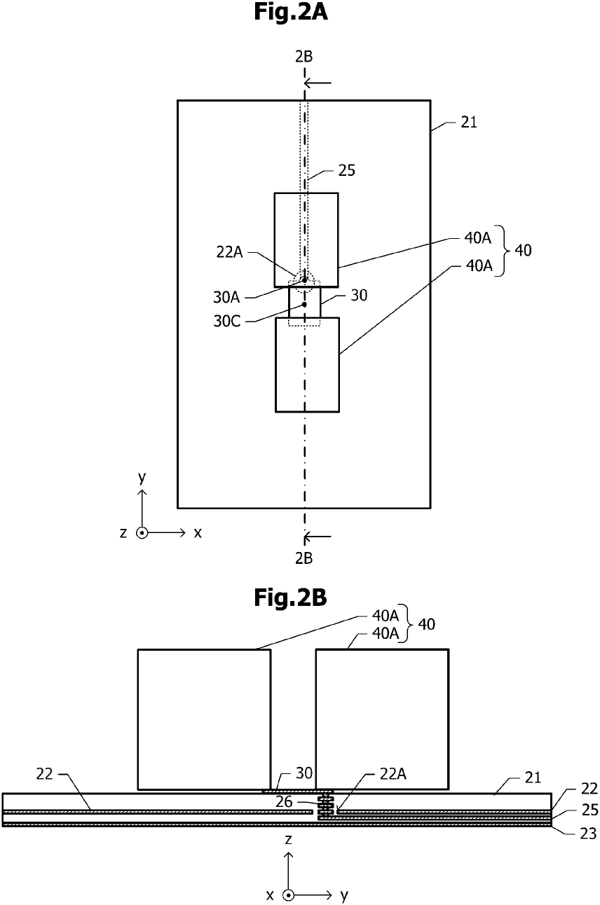

FIG. 1 is a perspective view of the antenna device according to the first embodiment. FIG. 2A is a plan view of the antenna device according to the first embodiment, and FIG. 2B is a sectional view of the antenna device in FIG. 2A taken along a dashed-and-dotted line 2B-2B.

The antenna device according to the first embodiment includes a substrate 21, a radiating electrode 30, and a dielectric member 40. The substrate 21 is a multilayer wiring substrate in which dielectric layers and wiring layers are alternately laminated, and has a ground conductor plate 22 disposed in an inner layer, a ground conductor plate 23 disposed on one surface, and a feed line 25 disposed between the two ground conductor plates 22 and 23. The feed line 25 constitutes a strip line together with the ground conductor plates 22 and 23.

The radiating electrode 30 is disposed above the ground conductor plate 22 with a space in a thickness direction of the substrate 21. For example, the radiating electrode 30 is disposed on a surface opposite to the surface on which the ground conductor plate 23 is disposed. A shape of the radiating electrode 30 in plan view is a square or a rectangle, for example. A feed point 30A is disposed at a midpoint of one edge of the radiating electrode 30, or between a geometric center of the radiating electrode 30 and the midpoint of the one edge. An xyz orthogonal coordinate system is defined, in which a direction of a straight line connecting the geometric center of the radiating electrode 30 and the feed point 30A is a y-direction, and the thickness direction of the substrate 21 is a z-direction.

The feed point 30A of the radiating electrode 30 is connected to the feed line 25 via an interlayer connection conductor 26 (FIG. 2B). The interlayer connection conductor 26 is constituted of a plurality of inner layer lands and a plurality of vias. Note that an opening 22A is provided in the ground conductor plate 22, and the interlayer connection conductor 26 passes through the opening 22A.

A dielectric member 40 made of ceramic or resin is loaded on the radiating electrode 30. The dielectric member 40 includes two dielectric block portions 40A. The two dielectric block portions 40A are constituted of individual blocks isolated from each other. The dielectric block portion 40A is fixed to the substrate 21 by adhesive, for example. A shape of each of the dielectric block portions 40A is a rectangular parallelepiped or a cube, and each surface thereof is perpendicular to an x-direction, the y-direction, or the z-direction. Further, lengths of one dielectric block portion 40A in the x-direction, the y-direction, and the z-direction are substantially the same as those of the other dielectric block portion 40A.

The two dielectric block portions 40A are disposed with a distance in between in the y-direction across a geometric center 30C (FIG. 2A) of the radiating electrode 30 in plan view. A portion of each of the two dielectric block portions 40A overlaps a portion of the radiating electrode 30 in plan view, and a remaining portion of each of the two dielectric block portions 40A extends outside the radiating electrode 30 toward one side in the y-direction and toward both sides in the x-direction. That is, the remaining portion is disposed outside the radiating electrode 30 in plan view. Note that the remaining portion of each of the two dielectric block portions 40A may extend only in the y-direction.

Next, operation of the antenna device according to the first embodiment will be described.

When a radio frequency signal is supplied from the feed point 30A to the radiating electrode 30, the radiating electrode 30 is excited in the y-direction, and resonance occurs in the radiating electrode 30. The amplitude of an electric field becomes maximum at edges of both ends in the y-direction, and the edges of both ends in the y-direction serve as radiation sources of a radio wave. In the first embodiment, since each of the two radiation sources is included in the dielectric block portion 40A in plan view, each of the two radiation sources is coupled to the dielectric block portion 40A. Therefore, each of the two dielectric block portions 40A operates as a dielectric antenna. As a result, an excellent effect of increasing antenna gain may be obtained.

In order to obtain a desired antenna gain, a plurality of radiating electrodes 30 may be disposed to form an array. When the dielectric member 40 of the antenna device according to the first embodiment is loaded on each of the plurality of radiating electrodes 30, the antenna gain of each radiating electrode 30 is increased. This makes it possible to reduce the number of radiating electrodes 30 required to achieve the desired antenna gain. Therefore, an antenna device may be reduced in size.

Furthermore, when the number of the radiating electrodes 30 is decreased, it is possible to shorten a line length of the feed line 25 that supplies a radio frequency signal to each of the radiating electrodes 30. As a result, transmission loss due to the feed line 25 may be reduced.

In particular, the effect is remarkably exhibited when the antenna device according to the first embodiment is applied to an antenna device in a millimeter wave band in which transmission loss is likely to increase.

In order to confirm the effect of the first embodiment, a simulation was performed to obtain the antenna gain of each of the antenna device according to the first embodiment and an antenna device according to a comparative example. Next, simulation results will be described.

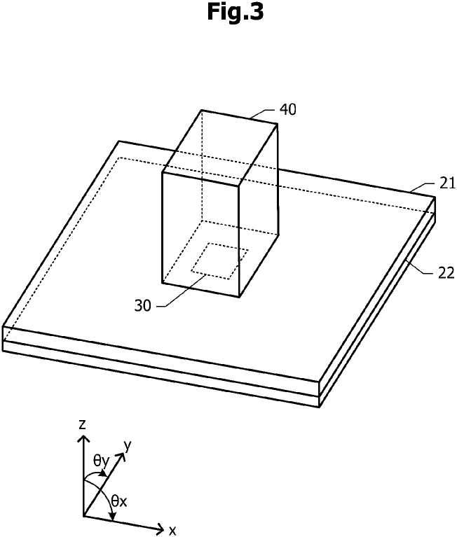

FIG. 3 is a perspective view of the antenna device according to the comparative example. In the antenna device according to the comparative example, the dielectric member 40 is constituted of one dielectric block. The radiating electrode 30 is included in the dielectric member 40 in plan view.

Next, a simulation model will be described.

In a simulation model of the antenna device according to the first embodiment, lengths of the radiating electrode 30 in the x-direction and the y-direction were set to 0.5 mm and 0.7 mm, respectively. Lengths of the dielectric block portion 40A in the x-direction, the y-direction, and the z-direction were set to 1.0 mm, 1.5 mm, and 1.6 mm, respectively. The distance between the two dielectric block portions 40A in the y-direction was set to 0.5 mm. In plan view, a midpoint of a line segment, which connects geometric centers of the two dielectric block portions 40A, coincides with the geometric center of the radiating electrode 30. At this time, a length in the x-direction of each of extending portions of the dielectric block portion 40A, from the radiating electrode 30 to both sides in the x-direction, is 0.25 mm. A relative dielectric constant of the dielectric block portion 40A was set to 6.

In a simulation model of the antenna device according to the comparative example (FIG. 3), the size of the radiating electrode 30 was set to be the same as the size of the radiating electrode 30 of the simulation model of the antenna device according to the first embodiment. The shape and size of the dielectric block were made identical to those of one dielectric block portion 40A of the simulation model of the antenna device according to the first embodiment.

Further, a simulation was also performed on a patch antenna not loaded with a dielectric block. In the simulation model not loaded with the dielectric block, lengths of the radiating electrode 30 in the x-direction and y-direction were set to 1.1 mm and 1.04 mm, respectively. In any of the simulation models, in order to set the resonant frequency 79 GHz, the length of each portion was adjusted.

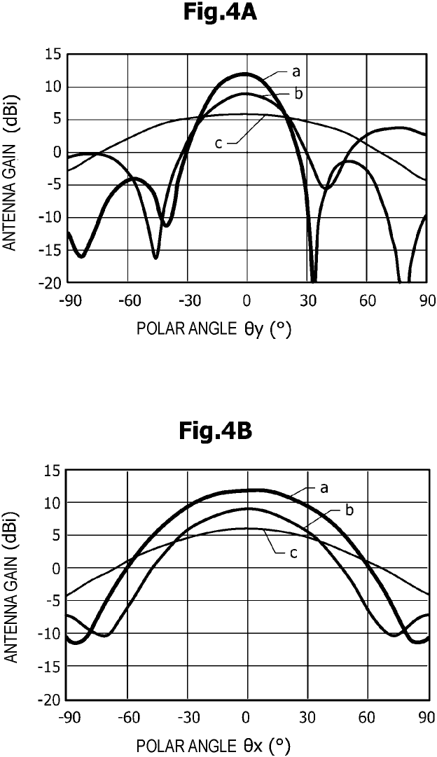

FIG. 4A and FIG. 4B are graphs illustrating directional characteristics in the yz plane and the xz plane, respectively. A horizontal axis of FIG. 4A represents a polar angle θy from the z-direction to a positive direction of a y-axis in a unit of “degree”, and a horizontal axis of FIG. 4B represents a polar angle θx from the z-direction to a positive direction of an x-axis in a unit of “degree”. A vertical axis of each of FIG. 4A and FIG. 4B represents antenna gain in a unit of “dBi”. Curves a, b, and c illustrated in FIG. 4A and FIG. 4B respectively represent simulation results of the antenna gain of the antenna device according to the first embodiment, the antenna device according to the comparative example in FIG. 3, and the antenna device not loaded with a dielectric block.

The antenna gain in the front direction (θx = θy = 0°) of the antenna device is the highest in the antenna device according to the first embodiment, and is the lowest in the antenna device not loaded with a dielectric block. With this, it is understood that loading a dielectric block increases the antenna gain in the front direction. Further, it is understood that disposing the two dielectric block portions 40A with a distance in the y-direction as in the first embodiment further increases the antenna gain in the front direction.

Further, with respect to the y-direction, a null point appears in a range of 30° to 40° of the polar angle θy. This suggests that each of the two dielectric block portions 40A functions as a radiation source.

Next, results of simulations of the antenna device according to the first embodiment, performed on a plurality of simulation models having different distances between the two dielectric block portions 40A, will be described.

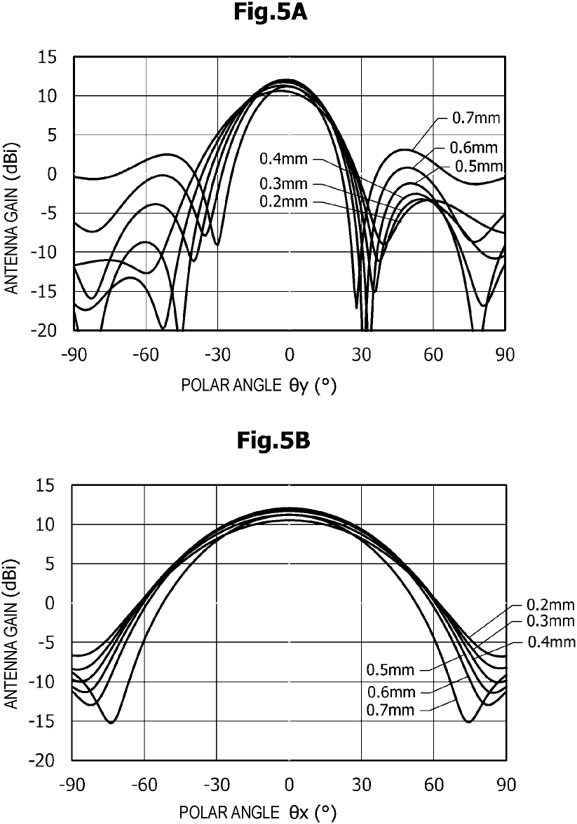

FIG. 5A and FIG. 5B are graphs illustrating directional characteristics in the yz plane and the xz plane of the simulation models having different distances between the two dielectric block portions 40A, respectively. A horizontal axis of FIG. 5A represents the polar angle θy from the z-direction to the y-direction in a unit of “degree”, and a horizontal axis of FIG. 5B represents the polar angle θx from the z-direction to the x-direction in a unit of “degree”. A vertical axis of each of FIG. 5A and FIG. 5B represents antenna gain in a unit of “dBi”. A numerical value attached to each curve in FIG. 5A and FIG. 5B shows a distance between the two dielectric block portions 40A.

It is understood that each of the directional characteristics of the antenna device and the antenna gain in the front direction changes when the distance between the two dielectric block portions 40A changes.

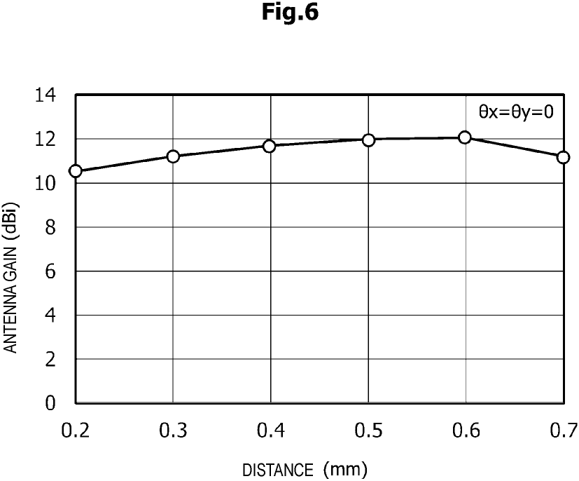

FIG. 6 is a graph illustrating a relationship of the distance between the two dielectric block portions 40A and the antenna gain in the front direction. A horizontal axis represents the distance between the two dielectric block portions 40A in a unit of “mm”, and a vertical axis represents the antenna gain in the front direction in a unit of “dBi”. In a simulation model in which the distance is 0.7 mm, edges of the two dielectric block portions 40A parallel to the x-direction coincide with edges of the radiating electrode 30 parallel to the x-direction, in plan view. That is, the dielectric block portion 40A and the radiating electrode 30 are in contact with each other, but do not overlap each other in plan view.

The antenna gain in the front direction depends on the distance between the two dielectric block portions 40A, and exhibits a maximum value when the distance is in a range of 0.5 mm or more and 0.6 mm or less. When the two dielectric block portions 40A are too close to each other, there becomes small the difference from the configuration in which one dielectric block is loaded as in the comparative example in FIG. 3, and the antenna gain lowers. It is understood that there is a suitable range of the distance between the two dielectric block portions 40A for maximizing the antenna gain in the front direction.

It is understood in FIG. 6 that there may be obtained an antenna gain equivalent to that of a case in which each of the dielectric block portions 40A is in contact with the radiating electrode 30 in plan view, when the distance between the two dielectric block portions 40A is in a range of 0.3 mm or more. Therefore, it is conceived that the distance between the two dielectric block portions 40A can be 40% or more of the length of the radiating electrode 30 in the y-direction. Further, from FIG. 6, it is conceived that the distance between the two dielectric block portions 40A can be 70% or more and 85% or less of the length of the radiating electrode 30 in the y-direction.

Next, the size and a dielectric constant of the dielectric member 40 (FIG. 1, FIG. 2A, and FIG. 2B) will be described. A suitable size of each of the two dielectric block portions 40A constituting the dielectric member 40 depends on a wavelength of a radio wave to be radiated, the wavelength in the dielectric block portion 40A. That is, the suitable size of the dielectric block portion 40A is determined by the wavelength at a resonant frequency of the radiating electrode 30 and the dielectric constant of the dielectric block portion 40A. The size of the dielectric block portion 40A may be adjusted by performing a simulation or an evaluation experiment to maximize the antenna gain.

Next, a modification of the first embodiment will be described.

In the first embodiment, the shape of the dielectric block portion 40A is a cube or a rectangular parallelepiped, but may be another shape. For example, the shape of the dielectric block portion 40A may be a cylindrical shape or an elliptic cylindrical shape.

### Second Embodiment

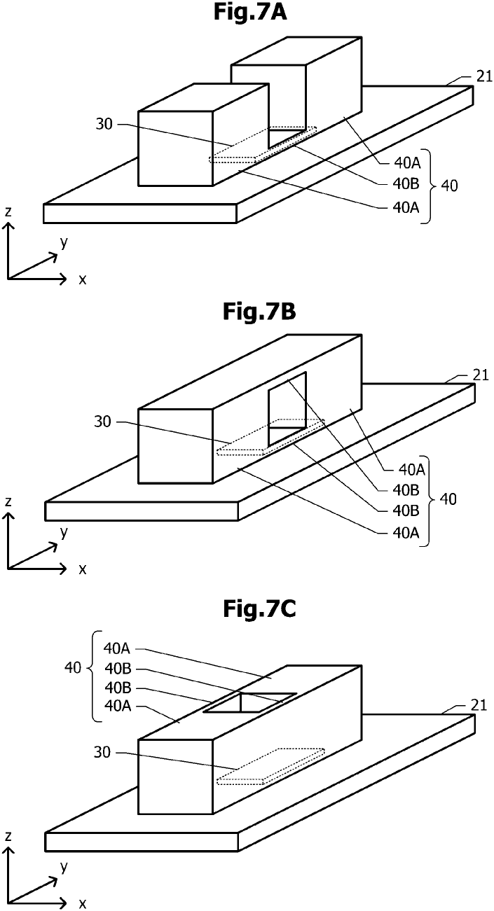

Next, an antenna device according to a second embodiment will be described with reference to FIG. 7A. Hereinafter, a description of a configuration common to that of the antenna device according to the first embodiment (FIG. 1, FIG. 2A, and FIG. 2B) will be omitted.

FIG. 7A is a perspective view of the antenna device according to the second embodiment. In the first embodiment, the dielectric member 40 includes two dielectric block portions 40A isolated from each other. On the other hand, in the second embodiment, two dielectric block portions 40A are connected to each other by a connection portion 40B. The connection portion 40B is continuous with partial regions including lower side (a substrate 21 side) edges of surfaces, of the two dielectric block portions 40A, facing each other. The surfaces, of the two dielectric block portions 40A and the connection portion 40B, facing the side of the substrate 21 are disposed on the same plane. The two dielectric block portions 40A and the connection portion 40B are made of the same dielectric material and are integrally formed.

A section of the connection portion 40B orthogonal to the y-direction (section parallel to the xz plane) is smaller than a section of each of the two dielectric block portions 40A orthogonal to the y-direction. Therefore, a gap is secured between the two dielectric block portions 40A.

Next, an excellent effect of the second embodiment will be described.

In the second embodiment, the two dielectric block portions 40A are connected to each other by the connection portion 40B. However, since a gap is secured between the two dielectric block portions 40A, the two dielectric block portions 40A have the same function as that of the dielectric block portion 40A, constituted of separate blocks, according to the first embodiment. Therefore, the antenna gain may be increased in the second embodiment as well.

Further, in the second embodiment, since the dielectric member 40 including the two dielectric block portions 40A is integrally formed, the number of components of the antenna device may be decreased. Furthermore, in the second embodiment, accuracy of the distance between the two dielectric block portions 40A does not depend on positional accuracy in fixing the dielectric member 40 to the substrate 21. Therefore, it is easy to increase the dimensional accuracy of the distance between the two dielectric block portions 40A.

When a ratio of a sectional area of the connection portion 40B perpendicular to the y-direction to a sectional area of the dielectric block portion 40A perpendicular to the y-direction approaches 1, effect of inclusion of the two dielectric block portions 40A by the dielectric member 40 lowers. In order to obtain a sufficient effect of disposing the two dielectric block portions 40A, the ratio of the sectional area of the connection portion 40B perpendicular to the y-direction to the sectional area of the dielectric block portion 40A perpendicular to the y-direction can be set to 0.3 or less.

Next, a modification of the second embodiment will be described with reference to FIG. 7B and FIG. 7C.

FIG. 7B and FIG. 7C are each a perspective view of an antenna device according to the modification of the second embodiment. One connection portion 40B for connecting the two dielectric block portions 40A is provided in the second embodiment, whereas two connection portions 40B are provided in the modification in FIG. 7B and FIG. 7C.

In the modification in FIG. 7B, the connection portions 40B are connected to two positions that are a lower end and an upper end (that is, both ends in the z-direction) of the surfaces, of the two dielectric block portions 40A, facing each other. In the modification in FIG. 7C, the connection portions 40B are connected to both ends in the x-direction of the surfaces, of the two dielectric block portions 40A, facing each other. As in the modifications in FIG. 7B and FIG. 7C, the plurality of connection portions 40B may be provided.

### Third Embodiment

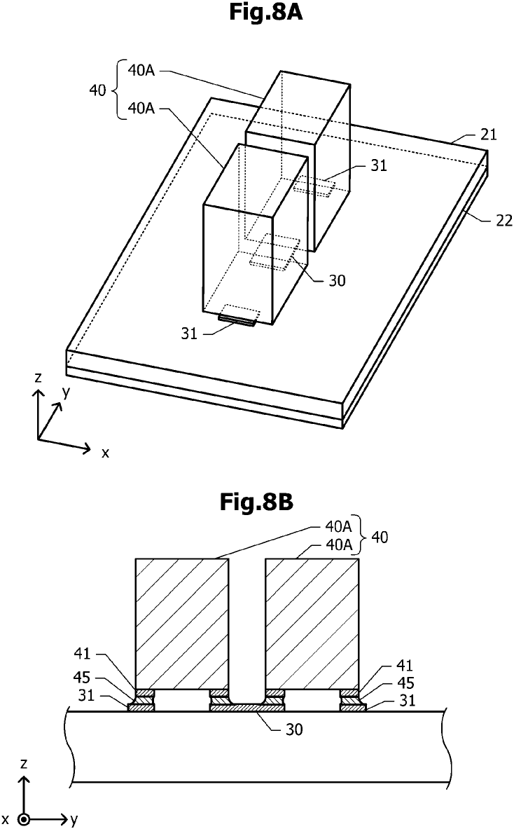

Next, an antenna device according to a third embodiment will be described with reference to FIG. 8A and FIG. 8B. Hereinafter, a description of a configuration common to that of the antenna device according to the first embodiment (FIG. 1, FIG. 2A, and FIG. 2B) will be omitted.

FIG. 8A and FIG. 8B are a perspective view and a sectional view of the antenna device according to the third embodiment, respectively. In the first embodiment (FIG. 1, FIG. 2A, and FIG. 2B), the two dielectric block portions 40A are fixed to the substrate 21 by adhesive or the like. On the other hand, in the third embodiment, two dielectric block portions 40A are fixed to the substrate 21 by solder.

Two first metal patterns 41 (FIG. 8B) are provided on a surface of a dielectric block portion 40A facing the substrate 21. The two first metal patterns 41 are disposed with a distance in the y-direction. For example, the two first metal patterns 41 are disposed at both ends in the y-direction of the lower surface of each dielectric block portion 40A. Second metal patterns 31 (FIG. 8B) are provided on an upper surface of the substrate 21 at respective positions with the radiating electrode 30 interposed therebetween in the y-direction in plan view.

One of the first metal patterns 41 on the dielectric block portion 40A is fixed to the radiating electrode 30 via solder 45, and the other of the first metal patterns 41 is fixed to the second metal pattern 31 via the solder 45.

Next, an excellent effect of the third embodiment will be described.

In the third embodiment as well as in the first embodiment, the antenna gain of the antenna device may be increased. As in the third embodiment, the dielectric block portion 40A may be fixed to the substrate 21 by the solder 45 instead of adhesive. When the relative positions of the radiating electrode 30, the second metal pattern 31, and the first metal pattern 41 have been adjusted, the dielectric block portion 40A may be positioned in a self-aligning manner during solder reflow.

Next, a modification of the third embodiment will be described.

In the third embodiment, the radiating electrode 30 is used as a metal pattern for connection by the solder 45, whereas a configuration may be employed in which the radiating electrode 30 is not used for fixing by solder. In the modification employing the configuration above, two second metal patterns 31 are disposed on the substrate 21 for each dielectric block portion 40A. In the case above, the two first metal patterns 41 on the dielectric block portion 40A may be fixed to the two second metal patterns 31 on the substrate 21 via the solder 45.

### Fourth Embodiment

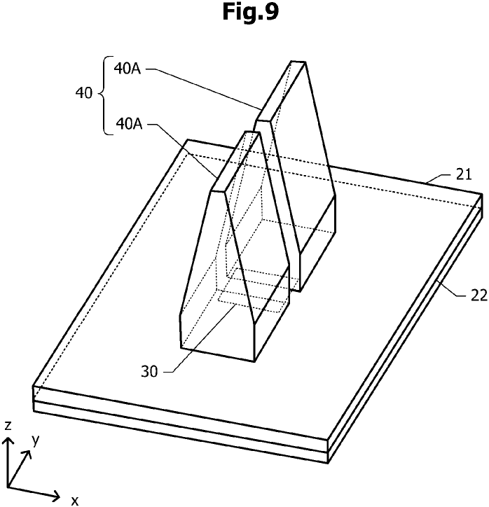

Next, an antenna device according to a fourth embodiment will be described with reference to FIG. 9. Hereinafter, a description of a configuration common to that of the antenna device according to the first embodiment (FIG. 1, FIG. 2A, and FIG. 2B) will be omitted.

FIG. 9 is a perspective view of the antenna device according to the fourth embodiment. In the first embodiment (FIG. 1, FIG. 2A, and FIG. 2B), the shape of each of the two dielectric block portions 40A is a cube or a rectangular parallelepiped. On the other hand, in the fourth embodiment, each of the two dielectric block portions 40A includes a tapered portion.

For example, a length in the x-direction is constant in a portion of the dielectric block portion 40A on the side of the substrate 21, and in an upper (positive direction of the z-axis) portion of the constant length portion, the length in the x-direction becomes smaller toward an upper side from the substrate 21.

Next, an excellent effect of the fourth embodiment will be described.

In the fourth embodiment as well as in the first embodiment, the antenna gain may be increased by disposing the two dielectric block portions 40A with a distance in the y-direction. Further, in the fourth embodiment, directivity of the antenna device may be changed by changing the shape of the dielectric block portion 40A from a cube or a rectangular parallelepiped. As in the fourth embodiment, making the length of the dielectric block portion 40A in the x-direction smaller toward the upper side makes it possible to widen directional characteristics in the xz plane.

Next, a modification of the fourth embodiment will be described.

The dielectric block portion 40A of the antenna device according to the fourth embodiment includes the tapered portion in which the length in the x-direction becomes smaller toward the upper side, but may include a tapered portion in which at least one of the length in the x-direction and the length in the y-direction becomes smaller toward the upper side. For example, the length in the y-direction may be made smaller toward the upper side while the length in the x-direction being constant, or both the lengths in the x-direction and the y-direction may be made smaller toward the upper side. For example, the shape of the dielectric block portion 40A may be a truncated quadrangular pyramid, a truncated cone, or the like.

### Fifth Embodiment

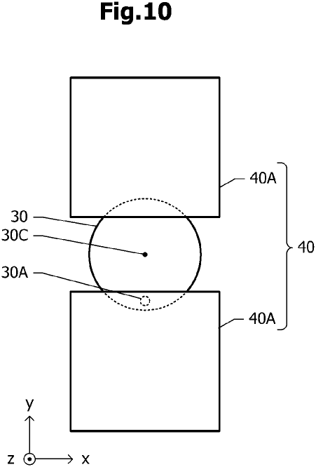

Next, an antenna device according to a fifth embodiment will be described with reference to FIG. 10. Hereinafter, a description of a configuration common to that of the antenna device according to the first embodiment (FIG. 1, FIG. 2A, and FIG. 2B) will be omitted.

FIG. 10 is a plan view of the antenna device according to the fifth embodiment. In the first embodiment (FIG. 1, FIG. 2A, and FIG. 2B), the shape of the radiating electrode 30 in plan view is a square or a rectangle, but a shape of a radiating electrode 30 of the antenna device according to the fifth embodiment in plan view is a circle. The feed point 30A is provided at a position where the geometric center 30C of the radiating electrode 30 is moved in the y-direction. In the fifth embodiment as well as in the first embodiment, the excitation direction of the radiating electrode 30 is parallel to the y-direction.

The two dielectric block portions 40A are disposed across the geometric center 30C of the radiating electrode 30 in the y-direction as well as in the first embodiment. Further, a portion of each of the dielectric block portions 40A overlaps a portion of the radiating electrode 30 in plan view.

Next, an excellent effect of the fifth embodiment will be described.

In the fifth embodiment as well as in the first embodiment, two portions of the radiating electrode 30 at which intensity of an electric field is maximized are included in the respective dielectric block portion 40A in plan view. With this, each of the radiation sources is coupled to the dielectric block portion 40A. Thus, the antenna gain may be increased as well as in the first embodiment.

Next, a modification of the fifth embodiment will be described. The shape of the radiating electrode 30 in plan view is a circle in the fifth embodiment, but another shape may be employed. For example, a shape in which each of four corners of a square is cut off in a small square, a corner-rounded rectangle, or the like may be employed.

### Sixth Embodiment

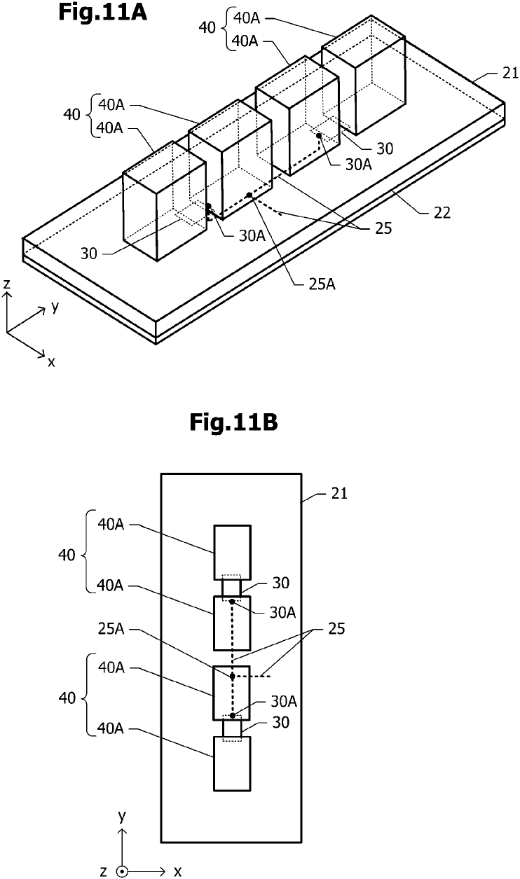

Next, an antenna device according to a sixth embodiment will be described with reference to FIG. 11A and FIG. 11B. Hereinafter, a description of a configuration common to that of the antenna device according to the first embodiment (FIG. 1, FIG. 2A, and FIG. 2B) will be omitted.

FIG. 11A and FIG. 11B are a perspective view and a plan view of the antenna device according to the sixth embodiment, respectively. The antenna device according to the first embodiment (FIG. 1, FIG. 2A, and FIG. 2B) has one radiating electrode 30. On the other hand, the antenna device according to the sixth embodiment has two radiating electrodes 30. The two radiating electrodes 30 are disposed with a distance in the y-direction.

A feed point 30A is provided at each of midpoints of edges, of the two radiating electrodes 30, facing each other. One feed line 25 is branched at a branch point 25A, and two branched feed lines 25 are connected to the respective two feed points 30A. A difference of a line length from the branch point 25A to one of the feed points 30A and a line length from the branch point 25A to the other of the feed points 30A is equal to a half of a wavelength corresponding to a resonant frequency of the radiating electrode 30. Therefore, the two feed points 30A are excited in opposite phases. Further, one of the two radiating electrodes 30 is provided with the feed point 30A at an end portion on a positive side of the y-axis, and the other of the two radiating electrodes 30 is provided with the feed point 30A at an end portion on a negative side of the y-axis. Therefore, the two radiating electrodes 30 are excited in the same phase in the y-direction.

The dielectric member 40 is loaded on each of the radiating electrodes 30. Each dielectric member 40 is constituted of the two dielectric block portions 40A.

Next, an excellent effect of the sixth embodiment will be described.

In the sixth embodiment, the antenna gain of each of the two radiating electrodes 30 may be increased. Therefore, the gain of the entire antenna device may be increased. Further, since the feed points 30A are provided at edges, of the two radiating electrodes 30, facing each other, a total line length from the branch point 25A to the two feed points 30A may be shortened. With this, an increase in transmission loss of a radio frequency signal transmitted through the feed line 25 may be suppressed. Further, exciting the two feed points 30A in opposite phases makes it possible to excite the two radiating electrodes 30 in the same phase in the y-direction.

Next, a modification of the sixth embodiment will be described.

The two radiating electrodes 30 are disposed in the sixth embodiment, but three or more radiating electrodes 30 may be disposed. In a case that the three or more radiating electrodes 30 are disposed, positions of the feed points 30A and the line length of the feed line 25 are adjusted such that all the radiating electrodes 30 are excited in the same phase in the y-direction. Since the antenna gain of each of the radiating electrodes 30 may be increased, the number of radiating electrodes 30 required to achieve a target antenna gain may be decreased. With this, reduction of the antenna device in size becomes possible.

In the sixth embodiment, the feed line 25 is branched into two at the branch point 25A to supply a radio frequency signal to the two radiating electrodes 30. As another configuration, a radio frequency signal may be distributed to the plurality of radiating electrodes 30 by using a distributor. Further, the plurality of radiating electrodes 30 may be excited with a predetermined phase difference. By providing the phase difference, a direction of a main beam of an antenna device may be inclined relative to the front direction.

### Seventh Embodiment

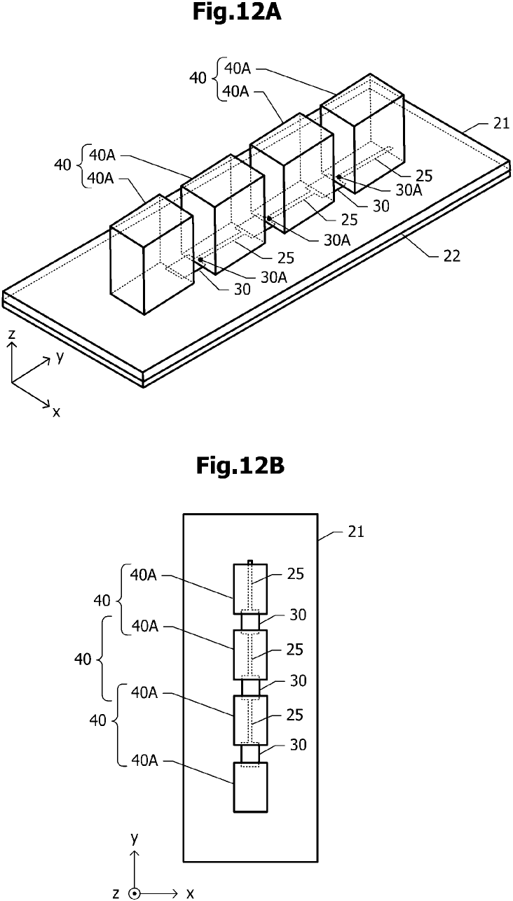

Next, an antenna device according to a seventh embodiment will be described with reference to FIG. 12A and FIG. 12B. Hereinafter, a description of a configuration common to that of the antenna device according to the sixth embodiment (FIG. 11A and FIG. 11B) will be omitted.

FIG. 12A and FIG. 12B are a perspective view and a plan view of the antenna device according to the seventh embodiment, respectively. In the antenna device according to the sixth embodiment (FIG. 11A and FIG. 11B), a parallel feed method is adopted as a feed method to the plurality of radiating electrodes 30, but in the antenna device according to the seventh embodiment, a series feed method is adopted. Specifically, a feed line 25 is connected to a feed point 30A of a first radiating electrode 30. The feed point 30A of the first radiating electrode 30 and a feed point 30A of a second radiating electrode 30 are connected by the feed line 25 connecting the radiating electrodes. Similarly, a feed point 30A of a preceding radiating electrode 30 and a feed point 30A of a subsequent radiating electrode 30 are connected by another feed line 25. A line length of the feed line 25 between the radiating electrodes 30 is adjusted such that a phase at the feed point 30A of the subsequent radiating electrode 30 is 360° behind with respect to that of the feed point 30A of the preceding radiating electrode 30.

One dielectric block portion 40A is disposed between radiating electrodes 30 adjacent to each other. The one dielectric block portion 40A overlaps a portion of each of the radiating electrodes 30 on both sides in plan view. Thus, the one dielectric block portion 40A is shared by the two radiating electrodes 30 adjacent to each other in the y-direction.

Next, an excellent effect of the seventh embodiment will be described. Since the series feed method is adopted in the seventh embodiment, the total line length of the feed line 25 may be shortened as compared with the antenna device adopting the parallel feed method. With this, transmission loss of a radio frequency signal transmitted through the feed line 25 may be reduced.

Further, in the seventh embodiment, each of the dielectric block portions 40A disposed at both ends in the y-direction is coupled to the one radiating electrode 30, whereas each of the dielectric block portions 40A (hereinafter referred to as the dielectric block portion 40A of an inner side) other than the dielectric block portions 40A disposed at both ends is coupled to the two radiating electrodes 30. Therefore, the dielectric block portion 40A of the inner side is excited more strongly than the dielectric block portions 40A at both ends. When each of the plurality of dielectric block portions 40A is used as a radiation source of a radio wave, energy of the radio wave radiated from the radiation sources at both ends is lower than energy of the radio wave radiated from the radiation source of the inner side. Therefore, a side lobe appearing in a radiation pattern in the yz plane may be suppressed.

### Eighth Embodiment

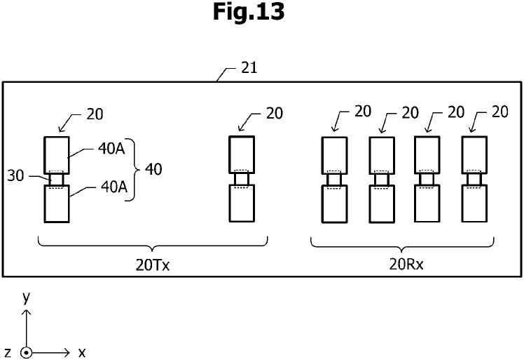

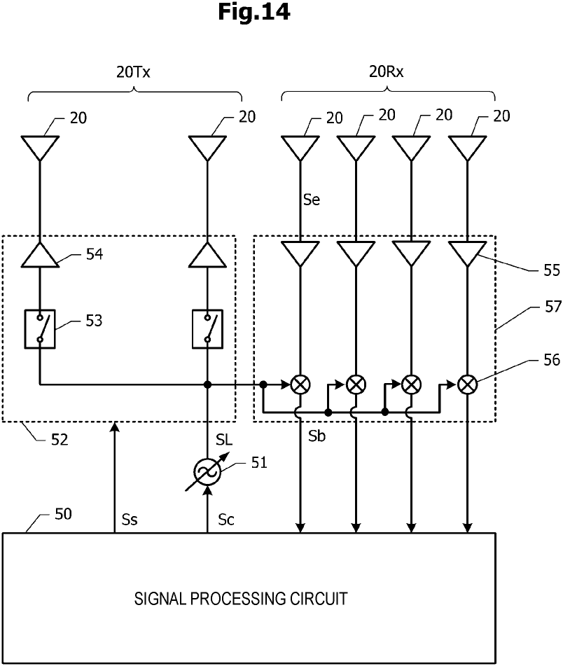

Next, a radar module according to an eighth embodiment will be described with reference to FIG. 13 and FIG. 14. In the radar module according to the eighth embodiment, the antenna device according to any one of the first to seventh embodiments or an antenna device obtained by combining the plurality of antenna devices according to the first to seventh embodiments is equipped.

FIG. 13 is a plan view of an antenna device equipped on the radar module according to the eighth embodiment. The antenna device according to the eighth embodiment includes an antenna element group 20Tx for transmission including a plurality of antenna elements 20, and an antenna element group 20Rx for reception including a plurality of antenna elements 20. Each of the antenna elements 20 includes one radiating electrode 30 and a dielectric member 40 loaded thereon. The dielectric member 40 includes two dielectric block portions 40A disposed with a distance in an excitation direction.

The plurality of antenna elements 20 is disposed in line in a direction (x-direction) orthogonal to the excitation direction (y-direction) of the radiating electrode 30 in plan view. For example, the antenna element group 20Tx for transmission includes two antenna elements 20, and the antenna element group 20Rx for reception includes four antenna elements 20.

FIG. 14 is a block diagram of the radar module according to the eighth embodiment. The radar module includes capabilities of Time Division Multiple Access (TDMA), Frequency Modulated Continuous Wave (FMCW), and Multiple Input Multiple Output (MIMO).

A local oscillator 51 outputs a local signal SL in which a frequency linearly increases or decreases along time, based on a chirp control signal Sc from a signal processing circuit 50. The local signal SL is provided to a transmission processing unit 52 and a reception processing unit 57.

The transmission processing unit 52 includes a plurality of switches 53 and a plurality of power amplifiers 54. The switch 53 and the power amplifier 54 are provided to the respective antenna elements 20 of the antenna element group 20Tx for transmission. The switch 53 is turned on and off based on a switching control signal Ss from the signal processing circuit 50. In a turn-on state of the switch 53, the local signal SL is inputted to the power amplifier 54. The power amplifier 54 amplifies the power of the local signal SL and supplies the amplified local signal SL to the antenna element 20 of the antenna element group 20Tx for transmission.

A radio wave radiated from the antenna elements 20 of the antenna element group 20Tx for transmission is reflected by a target, and the reflected wave is received by the plurality of antenna elements 20 of the antenna element group 20Rx for reception.

The reception processing unit 57 includes a plurality of low-noise amplifiers 55 and a plurality of mixers 56. The low-noise amplifier 55 and the mixer 56 are provided to the respective antenna elements 20 of the antenna element group 20Rx for reception. An echo signal Se received by the plurality of antenna elements 20 of the antenna element group 20Rx for reception is amplified by the low-noise amplifier 55. The mixer 56 multiplies the amplified echo signal Se and the local signal SL to generate a beat signal Sb.

The signal processing circuit 50 includes an AD converter, a microcomputer, and the like, for example, and performs signal processing on the beat signal Sb to generate position information related to a distance, azimuth, and the like to the target.

Next, an excellent effect of the eighth embodiment will be described.

In the eighth embodiment, the antenna device according to any one of the first to seventh embodiments is used for the plurality of antenna elements 20. This makes it possible to increase the antenna gain of each of the antenna elements 20. Under a condition of the same antenna gain, an antenna device may be reduced in size.

### Ninth Embodiment

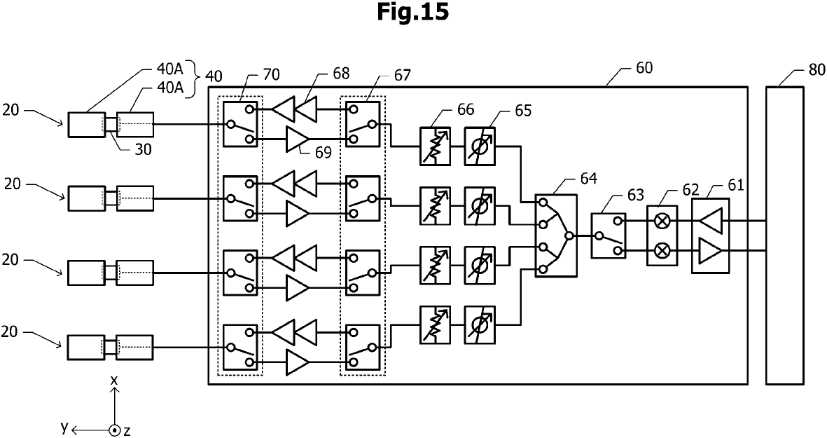

Next, a communication module according to a ninth embodiment will be described with reference to FIG. 15. In the communication module according to the ninth embodiment, the antenna device according to any one of the first to seventh embodiments or an antenna device obtained by combining the plurality of antenna devices according to the first to seventh embodiments is equipped.

FIG. 15 is a block diagram of the communication module according to the ninth embodiment.

The communication module according to the ninth embodiment includes a baseband integrated circuit element (BBIC) 80, a radio frequency integrated circuit element (RFIC) 60, and the plurality of antenna elements 20. The plurality of antenna elements 20 is aligned in a direction (x-direction) orthogonal to an excitation direction (y-direction) of the radiating electrode 30, and constitutes an array antenna. Each of the antenna elements 20 includes one radiating electrode 30 and a dielectric member 40 loaded on the radiating electrode 30. The dielectric member 40 includes two dielectric block portions 40A disposed with a distance in the y-direction.

The radio frequency integrated circuit element 60 includes an intermediate frequency amplifier 61, an up-down conversion mixer 62, a transmission/reception changeover switch 63, a power divider 64, a plurality of phase shifters 65, a plurality of attenuators 66, a plurality of transmission/reception changeover switches 67, a plurality of power amplifiers 68, a plurality of low-noise amplifiers 69, and a plurality of transmission/reception changeover switches 70.

First, a transmission capability will be described. An intermediate frequency signal is inputted from the baseband integrated circuit element 80 to the up-down conversion mixer 62 via the intermediate frequency amplifier 61. The up-down conversion mixer 62 up-converts the intermediate frequency signal to generate a radio frequency signal. The generated radio frequency signal is inputted to the power divider 64 via the transmission/reception changeover switch 63. Each of the radio frequency signals distributed by the power divider 64 is inputted to the antenna element 20 via the phase shifter 65, the attenuator 66, the transmission/reception changeover switch 67, the power amplifier 68, and the transmission/reception changeover switch 70.

Next, a reception capability will be described. A radio frequency signal received by each of the plurality of antenna elements 20 is inputted to the power divider 64 via the transmission/reception changeover switch 70, the low-noise amplifier 69, the transmission/reception changeover switch 67, the attenuator 66, and the phase shifter 65. The radio frequency signal combined by the power divider 64 is inputted to the up-down conversion mixer 62 via the transmission/reception changeover switch 63. The up-down conversion mixer 62 down-converts the radio frequency signal to generate an intermediate frequency signal. The generated intermediate frequency signal is inputted to the baseband integrated circuit element 80 via the intermediate frequency amplifier 61. Note that the up-down conversion mixer 62 may employ a direct conversion method of directly downconverting a radio frequency signal into a baseband signal.

Next, an excellent effect of the ninth embodiment will be described.

The antenna device according to any one of the first to seventh embodiments is used for the plurality of antenna elements 20 included in the communication module according to the ninth embodiment. This makes it possible to increase the antenna gain of each of the antenna elements 20. Under a condition of the same antenna gain, an antenna device may be reduced in size.

The above-described embodiments are merely examples, and it is needless to say that partial replacement or combination of configurations described in different embodiments is possible. A similar effect brought by a similar configuration in the plurality of embodiments will not be described for each embodiment. Further, the present disclosure is not limited to the embodiments described above. For example, it will be apparent to those skilled in the art that various modifications, improvements, combinations, and the like may be possible.

Reference Signs List

| | |
|---|---|
| 20 | ANTENNA ELEMENT |
| 20Rx | ANTENNA ELEMENT GROUP FOR RECEPTION |
| 20Tx | ANTENNA ELEMENT GROUP FOR TRANSMISSION |
| 21 | SUBSTRATE |
| 22 | GROUND CONDUCTOR PLATE |
| 22A | OPENING |
| 23 | GROUND CONDUCTOR PLATE |
| 25 | FEED LINE |
| 25A | BRANCH POINT |
| 26 | INTERLAYER CONNECTION CONDUCTOR |
| 30 | RADIATING ELECTRODE |
| 30A | FEED POINT |
| 30C | GEOMETRIC CENTER OF RADIATING ELECTRODE |
| 31 | SECOND METAL PATTERN |
| 40 | DIELECTRIC MEMBER |
| 40A | DIELECTRIC BLOCK PORTION |
| 40B | CONNECTION PORTION |
| 41 | FIRST METAL PATTERN |
| 45 | SOLDER |
| 50 | SIGNAL PROCESSING CIRCUIT |
| 51 | LOCAL OSCILLATOR |
| 52 | TRANSMISSION PROCESSING UNIT |
| 53 | SWITCH |
| 54 | POWER AMPLIFIER |
| 55 | LOW-NOISE AMPLIFIER |
| 56 | MIXER |
| 57 | RECEPTION PROCESSING UNIT |
| 60 | RADIO FREQUENCY INTEGRATED CIRCUIT ELEMENT (RFIC) |
| 61 | INTERMEDIATE FREQUENCY AMPLIFIER |
| 62 | UP-DOWN CONVERSION MIXER |
| 63 | TRANSMISSION/RECEPTION CHANGEOVER SWITCH |
| 64 | POWER DIVIDER |
| 65 | PHASE SHIFTER |
| 66 | ATTENUATOR |
| 67 | TRANSMISSION/RECEPTION CHANGEOVER SWITCH |
| 68 | POWER AMPLIFIER |
| 69 | LOW-NOISE AMPLIFIER |
| 70 | TRANSMISSION/RECEPTION CHANGEOVER SWITCH |
| 80 | BASEBAND INTEGRATED CIRCUIT ELEMENT (BBIC) |

1. An antenna device, comprising:
a substrate comprising a ground conductor plate;
a radiating electrode on the substrate, separated from the ground conductor plate in a thickness direction of the substrate; and
a dielectric on the radiating electrode,
wherein the dielectric comprises two dielectric blocks separated by a distance in a first direction, the first direction being an excitation direction of the radiating electrode, and
wherein in a plan view of the substrate:
the two dielectric blocks are symmetrically arranged across a geometric center of the radiating electrode, and
each of the two dielectric blocks at least partially overlaps the radiating electrode.

2. The antenna device according to claim 1, each of the two dielectric blocks is a rectangular parallelepiped or a cube.

3. The antenna device according to claim 1, wherein a dimension of each of the two dielectric blocks in the first direction or in a direction orthogonal to the first direction gradually decreases in the thickness direction.

4. The antenna device according to claim 1, wherein the two dielectric blocks are individual blocks isolated from each other.

5. The antenna device according to claim 1,
wherein the dielectric further comprises a connection that connects the two dielectric blocks to each other, and
wherein a section of the connection that is orthogonal to the first direction is smaller than a section of each of the two dielectric blocks that is orthogonal to the first direction.

6. The antenna device according to claim 1, comprising:
a plurality of the radiating electrodes aligned in the first direction, and
a plurality of the dielectrics, each of the plurality of dielectrics being on a corresponding one of the plurality of radiating electrodes.

7. The antenna device according to claim 6, wherein a dielectric block between two adjacent radiating electrodes at least partially overlaps each of the two adjacent radiating electrodes in plan view, and is shared by the two adjacent radiating electrodes.

8. The antenna device according to claim 1, further comprising:
a first metal pattern on a surface of each of the two dielectric blocks, the surface facing the substrate,
wherein the first metal pattern is fixed to the radiating electrode by solder.

9. The antenna device according to claim 8, comprising:
two first metal patterns on the surface of each of the two dielectric blocks; and
two second metal patterns on a surface of the substrate facing both the two dielectric blocks,
wherein one of the two first metal patterns is not fixed to the radiating electrode, and is fixed to a corresponding one of the two second metal patterns by solder.

10. A radar module, comprising:
a substrate comprising a ground conductor plate;
a plurality of transmission antennas on the substrate;
a plurality of reception antennas configured to receive a radio wave radiated from the plurality of transmission antennas and reflected by a target; and
a signal processing circuit configured to process a signal received by the plurality of reception antennas, and to generate position information of the target,
wherein each of the plurality of transmission and reception antennas comprises:
a plurality of radiating electrodes on the substrate, separated from the ground conductor plate in a thickness direction of the substrate; and
a plurality of dielectrics, each of the plurality of dielectrics being on a corresponding one of the plurality of radiating electrodes,
wherein an excitation direction of the plurality of radiating electrodes is parallel to a first direction,
wherein the plurality of transmission and reception antennas is aligned in a direction orthogonal to the first direction in plan view,
wherein each of the plurality of dielectrics comprises two dielectric blocks separated by a distance in the first direction, and
wherein, for each of the plurality of dielectrics in a plan view of the substrate:
the two dielectric blocks are symmetrically arranged across a geometric center of the corresponding radiating electrode, and
each of the two dielectric blocks at least partially overlaps the corresponding radiating electrode.

11. A communication module, comprising:
a substrate comprising a ground conductor plate;
a plurality of antennas on the substrate; and
a radio frequency integrated circuit configured to supply a radio frequency signal to the plurality of antennas, and to down-convert a radio frequency signal received by the plurality of antennas into an intermediate frequency signal or a baseband signal,
wherein each of the plurality of antennas comprises:
a plurality of radiating electrodes on the substrate, separated from the ground conductor plate in a thickness direction of the substrate; and
a plurality of dielectrics, each of the plurality of dielectrics being on a corresponding one of the plurality of radiating electrodes,
wherein an excitation direction of the plurality of radiating electrodes is parallel to a first direction,
wherein the plurality of antennas is aligned in a direction orthogonal to the first direction in plan view,
wherein each of the plurality of dielectrics comprises two dielectric blocks separated by a distance in the first direction, and
wherein, for each of the plurality of dielectrics in a plan view of the substrate:
the two dielectric blocks are symmetrically arranged across a geometric center of the corresponding radiating electrode, and
each of the two dielectric blocks at least partially overlaps the corresponding radiating electrode.
